(19) United States
(12) Patent Application Publication
(10) Pub. No.: US 2007/0045888 A1
(43) Pub. Date: Mar. 1, 2007

(54) Method of Making Light-Reflecting Article

(76) Inventors: Mao-Song Lee, Jen Te Hsian, Tainan County (TW); Hsi-Hsin Shih, Jen Te Hsian, Tainan County (TW); Shih-Kai Cheng, Jen Te Hsian, Tainan County (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 11/468,357

(22) Filed: Aug. 30, 2006

(30) Foreign Application Priority Data
Aug. 31, 2005 (TW) 94129960

(51) Int. Cl. B29C 44/20; B29C 44/56; B29C 59/02

(52) U.S. Cl. 264/45.9; 264/85; 264/284; 264/103; 264/321; 264/141

(57) ABSTRACT

Disclosed is a method of making a light-reflecting article comprising: mixing a polymer with a high-pressure gas or a supercritical fluid in an extruder to create a homogeneous single-phase mixture; and extruding the homogeneous single-phase mixture through a die to form an extrudate, wherein the resultant extrudate contains a polymer foam having micro voids with a mean cell diameter of no more than 200 μm.

### RELATED APPLICATIONS

The present application is based on, and claims priority from, Taiwan Application Serial Number 94129960, filed Aug. 31, 2005, the disclosure of which is hereby incorporated by reference herein in its entirety.

### FIELD OF THE INVENTION

This invention relates generally to a method of making a light-reflecting article, and more particularly, to a method of making a light-reflecting article with high diffusion reflection.

### BACKGROUND OF THE INVENTION

Conventional illuminating device, for example, the backlight module (BLM) applied in the liquid crystal display (LCD), typically has a light-reflecting article disposed thereon, which serves to reflect a point or line light source to an object (e.g. LCD panel). The light-reflecting article must have a high reflectivity, and a metal speculum is typically obtained by depositing a metallic film on a surface of a substrate. However, the diffusion reflection does not occur in the light-reflecting article with the metal speculum, so light-reflecting article with the metal speculum is hardly to attain a satisfying reflectivity function, and especially, to attain the diffusion reflection.

In comparison with the specular reflection that provides the light reflected at the same angle with the incident angle, the diffusion reflection provides the light reflected at various angles. The diffusely reflecting article can be obtained by roughing a reflecting surface, which involves, for example, spreading and adhering powder on a flat surface, treating a metal or glass surface in a manner of grinding or sand-blasting procedure, or introducing microdimple structures on an aluminum surface. However, there is a major disadvantage existed in such methods of roughing the reflecting surface, which provide neither enough nor evenly rough surface with the result that the resultantly reflecting surface has ill diffusion reflection.

Besides, a diffuse reflecting article produced by a polyester film having micro voids has been disclosed, which typically has incompatible polymer or inorganic microparticles dispersed in the polyester and voids formed around the incompatible microparticles. But it is very difficult to evenly disperse incompatible polymer or inorganic microparticles in the polyester, so that the voids are dispersed unevenly and the resultantly diffusion reflection is not good.

### SUMMARY OF THE INVENTION

Accordingly, an aspect of the present invention provides a method of making a light-reflecting article with high diffusion reflection.

According to the aforementioned aspect of the present invention, a method of making a light-reflecting article is provided, which comprises steps as follows. A high-pressure gas or a supercritical fluid is mixed with a polymer in an extruder to create a homogeneous single-phase mixture. And then, the homogeneous single-phase mixture is extruded through a die to form an extrudate. The extrudate includes a polymer foam having micro voids with a mean cell diameter of no more than 200 μm. The appropriate polymer may be polyolefin, polyolefin copolymer, cyclic olefin, cyclic olefin copolymer, polystyrene, polystyrene copolymer, acrylic resin, polycarbonate or mixtures thereof.

In a preferred embodiment of the present invention, the aforementioned die may be a sheet die for extruding into a sheet extrudate that can directly serve as the light-reflecting article of the present invention. Alternatively, the aforementioned die may be a tubular or ring-like die for extruding into a rod extrudate. In this embodiment, the rod can be woven into a net for serving as the light-reflecting article of the present invention. The aforementioned extrudate can be further impressed by using a mold having a micropattern, resulting in formation of prismatic or lenticular microstructures on a surface of the extrudate.

According to the aforementioned aspect of the present invention, a method of making a light-reflecting article is further provided, which comprises the step as follows. Foamed polymer beads each containing micro voids inside with a mean cell diameter of no more than 200 μm are subjected to a hot pressing procedure, so as to produce the light-reflecting article.

In another preferred embodiment of the present invention, the aforementioned foamed polymer beads are produced as follows. The polymer is granulated into polymer pellets. Next, the polymer pellets and a high-pressure gas or a supercritical fluid are loaded into a container. And then, a pressure in the container is lowered for expanding the polymer pellets into the foamed polymer beads each containing micro voids inside. In addition, the foamed polymer beads are alternatively produced as follows. The polymer is mixed with a high-pressure gas or a supercritical fluid in an extruder to create a homogeneous single-phase mixture. And then, the homogeneous single-phase mixture is extruded through a die to granulate the foamed polymer beads each containing micro voids inside.

### DETAILED DESCRIPTION OF THE PREFERRED EMBODIMENT

The present invention provides a light-reflecting article, which mainly includes a polymer foam having micro voids with a mean cell diameter of no more than 200 μm. The appropriate polymer of the present invention may be polyolefin, polyolefin copolymer, cyclic olefin, cyclic olefin copolymer, polystyrene, polystyrene copolymer, acrylic resin, polycarbonate or mixtures thereof.

If the micro voids have a mean cell diameter of more than 200 μm, the irregular reflecting times at the interface of the micro voids will be reduced. It results in that the light-reflecting article required for diffusely reflecting most incident light is too thick. In particular, when the sheet-like light-reflecting article is applied in the backlight module of LCD, the light returning to the LCD panel is easily lost and declined from the sides of the sheet-like light-reflecting article. Besides, if the mean cell diameter of the micro voids is smaller than the wavelength of the incident light, the incident light will pass through the polymer foam. Consequently, the mean cell diameter must be larger than or equal to the wavelength of the incident light. Preferably, the reflectivity of the light-reflecting article of the present invention is no less than 70%.

The method of making the light-reflecting article according to a preferred embodiment of the present invention comprises the step as follows. Foamed polymer beads each containing micro voids inside with a mean cell diameter of no more than 200 μm are subjected to a hot pressing procedure, so as to produce the light-reflecting article of the present invention. In which, the foamed polymer beads are further produced as follows. The polymer is granulated into polymer pellets. Next, the polymer pellets and a high-pressure gas or a supercritical fluid are loaded into a container. And then, a pressure in the container is lowered for expanding the polymer pellets into the foamed polymer beads each containing micro voids inside. The aforementioned method of making foamed polymer beads is described in detail according to Taiwan Patent Application Serial Number 94127598 filed on Aug. 12, 2005, the disclosure of which is hereby incorporated by reference herein in its entirety. In addition, the foamed polymer beads are alternatively produced as follows. The aforementioned polymer is mixed with a high-pressure gas or a supercritical fluid in an extruder to create a homogeneous single-phase mixture. And then, the homogeneous single-phase mixture is extruded through a die to granulate the foamed polymer beads each containing micro voids inside.

The method of making the light-reflecting article according to another preferred embodiment of the present invention comprises the step as follows. The aforementioned polymer is mixed with a high-pressure gas or a supercritical fluid in an extruder to create a homogeneous single-phase mixture. Next, the homogeneous single-phase mixture is extruded through a die to form an extrudate. The die may be a sheet die for extruding into a sheet extrudate that can directly serve as the light-reflecting article of the present invention. Alternatively, the die may be a tubular or ring-like die for extruding into a rod extrudate. In this embodiment, the rod can be woven into a net for serving as the light-reflecting article of the present invention. The above extrudate can be further impressed by using a mold having a micropattern, resulting in formation of prismatic or lenticular microstructures on a surface of the extrudate.

### EXAMPLE

Polypropylene particles, which have a standard grade of copolymer resin (Pro-Fax EP3C37F) of a melt flow index of 0.5 g/10 min and of a density of 0.91 g/cm³, are loaded through a feeding hopper into a twin-screw extruder. After carbon dioxide supercritical fluid in an amount of substantially 5.0% corresponding to the melting body is injected from the screw side, it is immediately mixed with the polypropylene fluid to be a homogeneous single-phase mixture. And then, the homogeneous single-phase mixture is extruded through a sheet die to obtain a polypropylene foam sheet having micro voids.

### TESTING RESULT

The reflectivity R₀ of the product of EXAMPLE at a wavelength of 550 nm is 94.7%, which is measured by a spectrophotometer (manufactured by DATACOLOR Co., Model No. SF-600).

As is understood by a person skilled in the art, the foregoing preferred embodiments of the present invention are illustrated of the present invention rather than limiting of the present invention. It is intended to cover various modifications and similar arrangements included within the spirit and scope of the appended claims. Therefore, the scope of which should be accorded the broadest interpretation so as to encompass all such modifications and similar structure.

What is claimed is:

1. A method of making a light-reflecting article, comprising:
mixing a polymer with a high-pressure gas or a supercritical fluid in an extruder to create a homogeneous single-phase mixture, wherein the polymer is selected from the group consisting of polyolefin, polyolefin copolymer, cyclic olefin, cyclic olefin copolymer, polystyrene, polystyrene copolymer, acrylic resin, polycarbonate and mixtures thereof; and
extruding the homogeneous single-phase mixture through a die to form an extrudate, wherein the extrudate includes a polymer foam having micro voids with a mean cell diameter of no more than 200 μm.

2. The method of making the light-reflecting article according to claim 1, wherein the high-pressure gas is selected from the group consisting of carbon dioxide, nitrogen gas, hydrocarbon compounds, chlorofluorocarbon compounds and mixtures thereof.

3. The method of making the light-reflecting article according to claim 1, wherein the supercritical fluid is selected from the group essentially consisting of carbon dioxide, nitrogen gas and mixtures thereof.

4. The method of making the light-reflecting article according to claim 1, further comprising impressing a micropattern on the extrudate by using a mold having the micropattern, so as to form a microstructure on a surface of the extrudate.

5. The method of making the light-reflecting article according to claim 1, wherein the die is a sheet die for extruding the extrudate into a sheet.

6. The method of making the light-reflecting article according to claim 1, wherein the die is a tubular or ringlike die for extruding the extrudate into a rod, and the method of making the light-reflecting article further comprises a step of weaving the rod to a net.

7. The method of making the light-reflecting article according to claim 6, further comprising impressing a micropattern on the net by using a mold having the micropattern, so as to form a microstructure on a surface of the net.

8. A method of making a light-reflecting article, comprising:
hot pressing foamed polymer beads each containing micro voids inside, so as to produce the light-reflecting article,
wherein the micro voids have a mean cell diameter of no more than 200 μm, and the polymer is selected from the group consisting of polyolefin, polyolefin copolymer, cyclic olefin, cyclic olefin copolymer, polystyrene, polystyrene copolymer, acrylic resin, polycarbonate and mixtures thereof.

9. The method of making the light-reflecting article according to claim 8, wherein the foamed polymer beads each containing micro voids inside is produced by:
mixing the polymer with a high-pressure gas or a supercritical fluid in an extruder to create a homogeneous single-phase mixture; and
extruding the homogeneous single-phase mixture through a die to granulate the foamed polymer beads each containing micro voids inside.

10. The method of making the light-reflecting article according to claim 9, wherein the high-pressure gas is selected from the group consisting of carbon dioxide, nitrogen gas, hydrocarbon compounds, chlorofluorocarbon compounds and mixtures thereof.

11. The method of making the light-reflecting article according to claim 9, wherein the supercritical fluid is selected from the group essentially consisting of carbon dioxide, nitrogen gas and mixtures thereof.

12. The method of making the light-reflecting article according to claim 8, wherein the foamed polymer beads each containing micro voids inside are produced by:
extruding the polymer to granulate polymer pellets;
loading the polymer pellets and a high-pressure gas or a supercritical fluid into a container; and
lowering a pressure in the container for expanding the polymer pellets into the foamed polymer beads each containing micro voids inside.

13. The method of making the light-reflecting article according to claim 8, further comprising impressing a micropattern on the light-reflecting article by using a mold having the micropattern, so as to form a microstructure on a surface of the light-reflecting article.
